(19) United States
(12) Patent Application Publication
(10) Pub. No.: US 2009/0093995 A1
(43) Pub. Date: Apr. 9, 2009

(54) METHOD FOR EVALUATING A DIAGNOSTIC TEST

(76) Inventors: Raymond Woosley, Tucson, AZ (US); Jeffrey Cossman, Potomac, MD (US)

Correspondence Address: Hanify & King Professional Corporation, 1875 K STREET, SUITE 707, WASINGTON, DC, 20006, US

(21) Appl. No.: 12/248,560

(22) Filed: Oct. 9, 2008

Related U.S. Application Data
(60) Provisional application No. 60/960,649, filed on Oct. 9, 2007.

(51) Int. Cl. G21C 17/00

(52) U.S. Cl. 702/182

(57) ABSTRACT

One aspect of the present invention generally relates to a method for standardizing and evaluating a diagnostic test. The method includes generating at least one of a standard, control, or sample required for a validation. Then, the at least one of a standard, control, or sample is compared to at least one of an assay, protocol, or reagent for testing on a predetermined number of aspects of performance. Finally, an indicator that represents the performance of the diagnostic test. Preferably, the method is performed at a centralized location on a plurality of diagnostic tests.

### CROSS-REFERENCE TO RELATED APPLICATIONS

The present application claims priority to Provisional U.S. Patent No. 60/960,649, filed Oct. 9, 2007, the entirety of which is incorporated herein by reference.

### FIELD OF THE INVENTION

The present invention relates to diagnostic tests. More specifically, the present invention relates to method for evaluating and standardizing diagnostic tests.

### BACKGROUND OF THE INVENTION

Generally, a diagnostic test is any kind of medical procedure performed to aid in the diagnosis or detection of disease. There are countless diagnostics tests that span all areas of medicine and clinical specialties. A diagnostic test may be as simple and non-invasive as a hearing test, or it may be more invasive like a biopsy or endoscopy. In vitro diagnostics (IVDs) are medical procedures occuring outside the body that aid in the prediction, diagnosis, therapy, management, or monitoring of disease.

In 2004, the U.S. Food and Drug Administration (FDA) reported that in the prior ten year period the nation had increased its investment in biomedical research and development by 250% but the number of innovative new medical products submitted to the FDA for approval had declined by 50%. During this time, the failure rate for drugs entering clinical testing has doubled and cancer drugs, an area of intense investment, have the lowest clinical test success rate of all, only 4%. The FDA concluded that the lack of productivity is because developers are using the same research methods to test drugs today that they did fifty years ago.

These outdated methods have been especially problematic for cancer drug development because they have a “one size fits all” approach to therapy. This is an old principle that misses the mark with the most promising, targeted drugs that are effective in only those patients with the specific target. For example, drugs that target tumor proteins EGFR or Her2 benefit the subset of patients whose tumors express these targets. However, traditional drug testing methods require that the majority of patients have a good response in order to achieve an overall survival benefit and be considered effective.

Several healthcare trends are driving the demand for sophisticated, rapid detection technologies that are multiplexing, sensitive, specific, and cost-effective. One trend is personalized medicine, which is healthcare that is focused on preventive treatments tailored for each individual patient, in turn driving research and therapeutic efforts. Accessibility to health information on the Internet, increased healthcare education for the population, and an ageing population are placing pressure on healthcare providers for faster and more accurate diagnosis and treatment. Additionally, public and private payers, trying to manage soaring healthcare costs, are demanding more compelling cost-benefit analyses to support reimbursement for diagnostic testing. Taken together, these factors are driving the growth of the IVD market.

The IVD market has been continuously evolving over the past decade and is now most focused on larger systems that are integrated with different software and automation components and on developing screening and disease confirmation tests. As a result of this change, a growing number of mergers and acquisitions are taking place within the market as new investors, biotechnology, and technology companies are entering the market.

Currently, however, there is no federal laboratory for evaluating and standardizing diagnostics tests, including those that would guide targeted or conventional cancer therapy. Testing laboratories do exist to support FDA-regulated activities in other areas. For example, the US Pharmacopeia (USP) is an independent non-profit organization in existence for over 180 years that has served as the federally-sanctioned public standards setting authority for medicines and other healthcare products, but not diagnostics. The National Center for Food Safety and Technology (NCFST) standardizes safety testing for food. In addition, the USP and NCFST are examples of collaborative non-profit organizations with central testing facilities established to address a specialized regulatory requirement and are models for a national center for diagnostics evaluation.

Although IVD testing has been present as a service in many laboratories for more than a decade, the technology used for IVDs, particularly molecular diagnostics, is becoming more complex and requires additional measures to assure reliable and acceptable test results.

Within the U.S. Department of Health and Human Services (HHS), there are two primary agencies with regulatory oversight of IVDs: the Centers for Medicare & Medicaid Services (CMS), which regulates genetic testing service providers through the Clinical Laboratory Improvement Amendments of 1988 (CLIA), to which more than 175,000 U.S. clinical laboratories adhere, and the U.S. Food and Drug Administration (FDA), which oversees all laboratory tests and their components under the 1938 Federal Food, Drug, and Cosmetic Act, as amended by the Medical Device Amendments of 1976, the Safe Medical Devices Act of 1990, and the Medical Devices Amendments of 1992. All current quality assurance standards and thresholds for validation requirements for laboratories performing diagnostic analysis are high, although these benchmarks are expected to increase.

In the traditional model for FDA regulation of the IVD industry, diagnostics tests are developed by companies and then either cleared (510(k)) or approved (PMA) by the FDA. These companies then market the tests to clinical laboratories that are regulated under CLIA. However, many in vitro diagnostics companies initially marketed their products as analyte specific reagents (ASRs). These laboratory developed tests (LTDs) do not include full diagnostic kits. ASRs are univariate tests and measure only one molecular entity. As such, they are considered Class 1 devices, and do not need to go through the 510(k) or PMA processes. This enabled the companies to get their products to market more quickly.

As the industry has matured, it has become apparent that simple univariate diagnostics (i.e., ASRs) are not sophisticated enough to detect complex diseases reliably in a genetically heterogeneous population exposed to differing environmental factors. In vitro diagnostic multivariate index assays (IVDMIAs) are now beginning to enter the market.

IVDMIAs are defined as assays that:
1. Combine the value of multiple variables using an interpretation function to yield a single, patient-specific result (e.g., a “classification,” “score,” “index”) that is intended for use in the diagnosis of disease or other conditions, or in the cure, mitigation, treatment, or prevention of disease, and
2. Provide a result whose derivation is nontransparent and cannot be independently derived or verified by the end user.

In the case of IVDMIAs, the FDA has taken a significantly different position than for single variable tests as discussed above. In a document entitled “Draft Guidance for Industry, Clinical Laboratories, and FDA Staff—In Vitro Diagnostics Multivariate Index Assays,” originally issued in 2006 and most recently revised in July of 2007, the FDA seeks to enforce regulatory authority over IVDMIAs. Specifically, manufacturers must submit either a 510(k) or PMA submission for all new tests prior to marketing, and those tests currently on the market will have a 12 month period during which they can submit for approval, or the will “exercise enforcement discretion”—in other words force the manufacturers to remove the products from the market.

Clinical laboratories may face even more regulation in the future. In addition to the ongoing changes regarding IVDMIAs, proposals have been made to require increased regulation (including FDA regulation) of laboratory-developed tests. For example, both Senator Ted Kennedy and Senator Barack Obama have separately recently authored legislation that would increase oversight of laboratory-developed tests. Senator Kennedy's Laboratory Improvement Act would require providers of laboratory-developed tests to submit evidence of clinical and analytical utility of their tests to the FDA. Senator Obama's bill is called the Genomics & Personalized Medicine Act. If either of these bills, or similar legislation, is passed, clinical laboratories would face increased regulation of laboratory-developed tests.

The oversight of increasingly complex diagnostics is still evolving. Increased regulatory oversight by the FDA slows the process of bringing products to market and significantly increases the cost of development. However, these issues need to be weighed relative to the safety and efficacy of IVDMIAs. It is clear that a new regulatory paradigm, one that promotes both safety and speed to market, will need to develop as the industry matures.

As such, a continuing need exists for a centralized laboratory that implements a business method that allows for the evaluation and testing of diagnostic tests. Preferably, the business method allows a plurality of different diagnostic tests to be tested and evaluated in a central location.

### BRIEF DESCRIPTION OF THE DRAWINGS

Further features and advantages of the invention can be ascertained from the following detailed description that is provided in connection with the drawings described below:

FIG. 1 is flow chart showing exemplary steps according to one aspect of the present invention;

FIG. 2 is another flow chart showing exemplary steps according to another aspect of the present invention; and

FIGS. 3-5 are flow charts showing exemplary steps according to yet another aspect of the present invention.

### SUMMARY OF THE INVENTION

One aspect of the present invention relates to a method for standardizing and evaluating a diagnostic test. The method generally includes generating at least one of a standard, control, or sample required for a validation. Then, the at least one of a standard, control, or sample is compared to at least one of an assay, protocol, or reagent for testing on a predetermined number of aspects of performance. Finally, an indicator that represents the performance of the diagnostic test may be produced. An advantage of the present invention is that these steps are performed at a centralized location that can evaluate a plurality of diagnostic tests. In this manner, evaluation and approval of diagnostic tests is centralized and standardized.

In one embodiment, the producing comprises providing certification based on analytical and clinical evaluation studies when a diagnostic assay meets or exceeds minimum performance criteria established by a laboratory or standard setting body. This aids in assessing the effectiveness of the diagnostic test. Preferably, the present invention performs at least one of two different types of tests: (i) an analytical performance; or (ii) clinical validation and utility. Optionally, the analytical performance may first include the step of performing a pre-analytical test validation. In addition, the clinical validation and utility may include determining the clinical utility of a test. Preferably, each of the steps described above is performed on a plurality of tests in order to determine the effectiveness of each of the plurality of tests.

In another aspect, the present invention comprises a method of validating a diagnostic test. The method includes the steps of isolating a target required to be identified by the diagnostic test. In addition, the diagnostic test's ability to identify a target analyte may be tested, and an indicator that represents the ability of the diagnostic test to identify a target analyte is preferably produced. It is desirable for each of these steps to be performed in a centralized location, on a plurality of different diagnostic tests, in order to determine the ability of each of the plurality of diagnostic tests to identify the target.

In one embodiment, the method of validating may include testing a clinical sample including the target. Further, when the target is isolated, various determinations may be made including, but not limited to: (i) determining the accuracy of the diagnostic test; (ii) determining the precision of the diagnostic test; (iii) determining the specificity of the diagnostic test; (iv) determining the sensitivity of the diagnostic test; (v) determining the limits of the diagnostic test; or (vi) determining the carry-over and cross-hybridization potential of the diagnostic test.

Other types of tests may also be performed, including testing a clinical sample comprises testing the ability of the diagnostic test to detect or predict a disorder based on the target analyte or determining the ability of the diagnostic test to predict treatment response. In some embodiments, the ability to predict treatment responses includes generating samples with known associated outcomes. Then, the diagnostic test using the generated samples is evaluated and the ability of the diagnostic test to predict the known associated outcomes is then determined.

In this aspect, the method also includes using a repository of reusable standard samples including a purified target analyte, a tissue, fluids, preserved cells, or preserved tissues. The repository may be used to compare the results of the performance of different diagnostic assays against the same analyte. Alternately, the repository may be used with associated clinical information such as treatment history and outcome.

The method also includes the ability to cooperate with regulatory bodies or agencies. For instance, the method may also include generating diagnostic assay testing and validation data to support submission for approval by regulatory bodies and other agencies that evaluate proficiency and performance of clinical diagnostic tests. The regulatory bodies and other agencies include, but are not limited to, the FDA, EMEA (and equivalent), CAP, CLIA, ACGME, or ISO. The diagnostic testing and evaluation process enables the regulatory agencies to support the introduction and utilization of valid diagnostic tests in clinical practice.

Preferably, the diagnostic testing and evaluation process enhances and expedites the fair evaluation of the diagnostics by regulatory bodies. Finally, because commercialization of the diagnostic tests may be desirable, diagnostic assay data testing data to support due diligence for licensing and investing, or comparison to market competition, is generated.

### DETAILED DESCRIPTION OF THE PREFERRED EMBODIMENTS

Although the FDA needs laboratory data for review of diagnostic submissions for its approval, the FDA is neither equipped nor authorized to conduct this standard setting or testing activity. Therefore, the business method of the present invention relates to testing new diagnostic assays for treatment either prior to submission for FDA approval or as home brews. In particular, the laboratory that implements the present invention is the first national standard setting laboratory for cancer molecular diagnostics. It allows widespread, standardized use of diagnostics for new cancer treatments, breaking the logjam between scientific knowledge and effective treatment.

Most diagnostic laboratory tests are considered in vitro diagnostics (IVD's) and include reagents, instruments, software and systems intended for use in the diagnosis of disease or other conditions, including a determination of the state of health, in order to cure, mitigate, treat, or prevent disease or its sequelae. Such products are intended for use in the collection, preparation, and examination of specimens taken from the human body. IVD's are medical devices, and are regulated by the FDA.

Laboratory developed tests (LTDs or “home brews”) are developed and provided as a service or test by a laboratory, such as a university medical center, and regulated by Centers for Medicare and Medicaid Services (CMS) under the Clinical Laboratory Improvement Act (CLIA) rather than by the FDA. Most genetic tests currently fall under the CLIA-regulated category. The process described herein enables standardization, evaluation and reporting intended for regulation by any regulatory body, including, but not limited to, FDA, CLIA, and agencies outside of the United States.

Before diagnostic tests can be broadly marketed in interstate commerce, most must be submitted to the FDA for approval. In vitro diagnostic assays or systems require 510(k) or PMA approval by the FDA, both of which require performance testing. For 510(k), a test is considered to be similar to a previously approved test whereas a PMA is a more complete evaluation that is required for a novel test. The method of the present invention is intended to be applied to any diagnostic, including 510(k) and PMA. For approval by FDA, CLIA, and other regulatory bodies, the tests must show evidence of validity in order for the test to be accepted by the medical community and ordered by clinicians.

Currently, there is no federal, commercial, or non-profit laboratory for evaluating and standardizing the performance of diagnostic tests prior to their submission to the FDA for review of their clinical utility and approval or commercialization. Thus, one advantage of the present invention is that one aspect performs these functions by serving as the testing and evaluation body for diagnostics tests. Generally, the present invention produces or secures the standards, controls, and test samples required for validation of a new assay. Sponsors may then submit their assays, equipment, software, protocols, standard operating procedures (“SOPs”) and reagents to be tested on all aspects of performance. Sponsors pay for the validation service and provide a result, e.g., pass/failure of certification.

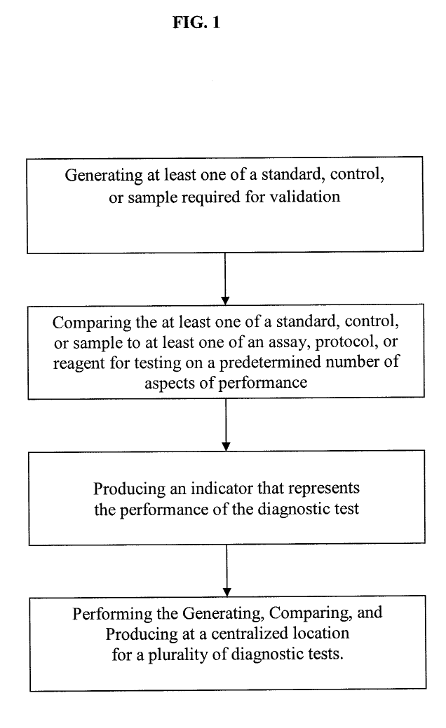

To address the problems described above, the present invention relates to a business method for standardizing and evaluating a diagnostic test. With reference to FIG. 1, the method generally includes generating at least one of a standard, control, or sample required for validation. Then, the standard, control, or sample is compared to at least one of an assay, protocol, or reagent for testing on a predetermined number of aspects of performance. Finally, an indicator is produced that represents the performance of the diagnostic test.

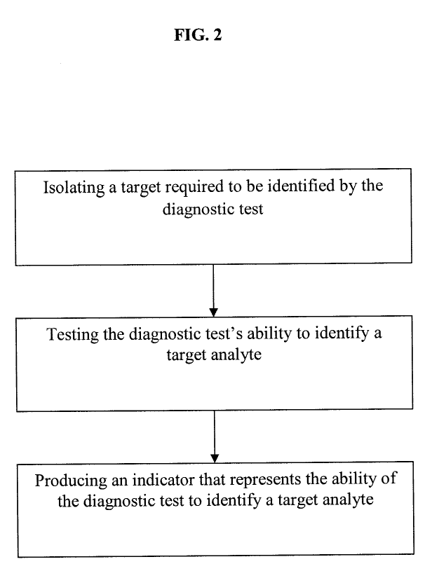

In another aspect, as shown in FIG. 2, the method of the present invention includes isolating a target required to be identified by the diagnostic test. In this embodiment, the diagnostic test's ability to identify a target analyte is tested, and an indicator is produced to represent the ability of the diagnostic test to identify a target analyte.

A general advantage of various aspects of the present invention is that the development, evaluation, and certification of in vitro diagnostics (IVDs) may be accelerated by acting as an independent bridge between the government and industry. Currently, there is no independent national laboratory for evaluating and standardizing diagnostics. The present invention relates to a method that may be used by a laboratory to function as the nation's system for evaluation and certification of IVDs. Working closely with the FDA, the laboratory implementing the business method of the present invention will design testing protocols, procure and manage clinical samples, process test data, and create reports suitable for submission to the FDA for approval by its Office of In Vitro Diagnostics and for providers and payers to support either IVDs or LTDs.

In addition, the laboratory that implements the business method of the present invention preferably works with the National Institute for Standards Technology (NIST). NIST's mission is to promote U.S. innovation and industrial competitiveness by advancing measurement science, standards, and technology in ways that enhance economic security and improve our quality of life. The present invention's partnership with NIST allows it to provide standardized testing of platforms to determine precise, comparative measurement.

In one aspect, the present invention provides a method for evaluation and certification of a plurality of diagnostic tests, such as IVDs and LTDs. Though the present invention applies to the evaluation and certification of all laboratory diagnostics, it is contemplated that a focus may be placed on molecular diagnostics. In addition to evaluation and certification, the present invention may allow for the creation of other entities that provide consulting and testing services.

The present invention may be used in combination with various entities, e.g., customers. For instance, entities that may be customers include diagnostic test development companies, academic laboratories with a diagnostic test (LTD), or investors considering licensing or acquiring the rights to diagnostic tests. Alternately, companies that need to perform due diligence for in-licensing, proficiency testing agencies that need samples and processes, payors, or other government or other regulatory agencies may all be customers.

According to one aspect, the present invention comprises a business method that offers services such as: (a) analytical performance; and (b) clinical utility evaluation of diagnostics. To run these tests, the present invention establishes industry-recognized standard operating procedures (SOPs) and protocols, develops thoroughly tested positive and negative controls, and bank certified, standardized clinical specimens for testing. Additionally, the method of the present invention runs analytical evaluations on diagnostics tests, judging them against established controls. In these evaluations, sensitivity, specificity, positive and negative predictive values, reproducibility, linearity, and robustness may be measured.

Optionally, an aspect of the method of the present invention may record all test results and establish a database of analytical information for the IVD market, which preferably grows in both size and value with each evaluation performed. In addition to the quantitative evaluation data provided to customers, the present invention uses its database to provide customers with qualitative, comparative data against other diagnostics in the market. By doing this, the present invention benchmarks customers' results against the rest of the industry. For clarity, the present invention presents its finding in a format that is already tailored for FDA filings and reports.

As mentioned above, a first step in the method of the present invention is to establish industry-wide acceptance of its SOPs, protocols, and standards. In one embodiment, this may be accomplished by requesting proposals from various industry players and stakeholders, making the proposals anonymous, and then holding a vote to obtain industry consensus. These standards may then be shared with third parties, e.g., customers, (either through sale or free consult) to aid in its customers' R&D process and speed the process of evaluation by the present invention, and eventually by a regulatory agency, e.g., the FDA.

It is desirable for the present invention to include the ability to either bank, or secure access to, certified and standardized clinical samples to evaluate diagnostics. In one embodiment, the clinical sample banks are preferably a permanent, renewable resource that uses: (a) standardization protocols for replacement samples; and (b) proprietary preservation methods. The biorepository may include samples with good clinical annotation and outcome information so that one implementation of the present invention will be able to evaluate diagnostics designed for a disease state and clinical utility.

According to one embodiment, the present invention generally provides a variety of capabilities described briefly above. For instance, one step in the method of the present invention is to generate a consensus. A consensus is important in the field of diagnostics because without reaching an agreement with the major participants in the industry, very little can be achieved. Preferably, a consensus will be built among various industry participants including, but not limited to, academia, industry, regulators, practice and reimbursement institutions, and the like. A consensus is preferably reached as to the need and acceptance of a national diagnostics standards process. As those skilled in the art will understand, the type of consensus necessary may be different for different types of diagnostic tests or industries.

Another step that may be included in the business method of the present invention is to ensure neutrality. That is, the method of the present invention is preferably neutral with respect to all parties, and in particular with respect to industry and regulatory agencies. Also important is the ability to establish quality standards. In other words, the test method of the present invention shares results and methods and is subject to inspection and accreditation by regulatory agencies, such as Clinical Laboratory Improvement Amendments (CLIA), College of American Pathology (CAP), International Organization for Standardization (ISO) standards, and any other applicable organization or regulation.

According to one embodiment, the business method of the present invention includes a method for evaluating the performance of diagnostic tests through laboratory testing. Several different tests may be used as desired, as discussed below.

For instance, a first type of test that may be used is a pre-analytical test validation. One advantage of this type of test is that the effect of different sample preparation conditions on the analytical accuracy of the test may be evaluated. These conditions include, but are not limited to, type of fixation of the tissue, refrigeration of the specimen, preservative and matrix solutions, isolation of nucleic acid or protein, purification of a cell subpopulation, alliquoting and storage of samples, and/or specimen dilutions. A second type of test that may be used is referred to as analytical test validation. Analytical test validation is preferably designed to test the in assay's ability to accurately and reliably measure the target analyte. In this embodiment, it may be desirable to have the purified target (protein, DNA, RNA or other biomolecules) required to perform the assays, as well as well-characterized clinical samples and/or cell lines expressing the target that would represent and comprise the range and types of clinical samples to be tested in routine conditions

The ability to accurately and reliably measure the target analyte may include, but is not limited to evaluation of accuracy, precision (repeatability/reproducibility), specificity, sensitivity, limits of detection, sample carry-over and cross-hybridization potential, controls and calibrators, and comparability. In other embodiments, analytical test validation may include, but is not limited to, the evaluation of precision (intra and inter assay reproducibility), linearity, analytical sensitivity and specificity, reliable quantification ranges, quantification precision, and positivity thresholds. Additionally, the test may include a comparison of the analytical performance of the test with similar tests under the same standards and controls.

For instance, one aspect of the present invention includes the ability to perform analytical validation of an antibody or a nucleic acid. This type of test involves the characterization of an antibody or a nucleic acid probe with respect to: (a) target binding specificity; (b) association and dissociation constants (affinity); (c) melting temperature Tm (melting temperature of a nucleic acid probe) and ideal binding conditions or a probe; (d) target cross reactivities and tissue specificity; and (e) positivity and negativity ranges.

Another type of test that may be used is referred to as clinical test validation. This type of test is designed to determine the statistical association of the test target analyte with defined clinical conditions and respective controls, with a defined parameter of clinical outcome, or with a defined parameter of therapy response. The intention of this type of test is to measure statistical values like clinical sensitivity and clinical specificity, clinical positive predictive value, clinical negative predictive value, ROC calculations, and/or relative risk and odds ratios. The clinical validation test may be performed with retrospective clinical specimens or in a randomized prospective trial.

This study can involve a comparative analysis of the test in question with other similar tests under the same set of conditions and the same clinical specimens and controls. In other words, this type of test is designed to test the ability of the assay to detect or predict the disorder in patients and assess the same criteria described in analytical test validation on biological samples. In some embodiments, the utility of the clinical test may be evaluated. Such a test may aim to determine the clinical value of a particular test, e.g., prediction of treatment response. Where applicable, the clinical utility is measured against samples with known associated outcomes.

Another similar type of test may include testing to determine the clinical utility of a test. This type of test requires a prospective clinical trial, and adds to the clinical test validation in order to investigate the impact that a positive or negative result of a test can have on well defined clinical and economical parameters. These parameters may include, but are not limited to, clinical remission, clinical recurrence (disease-free survival), death (overall survival), objective clinical complications predicted by the test or directly related to the result of the test, hospitalization events associated with clinical practices determined by the result of the test, and/or costs directly associated with the clinical management which has been directly determined as a result of the test

When possible, the clinical tests use clinical samples that are secured and stored. Subsequently, the ability of the test to predict clinical outcome is evaluated. Preferably, a reserve of samples is available to evaluate any subsequently developed tests, which allows tests to be compared to one another. Referred to herein as the “sample standards repository,” this reserve includes a collection of highly qualified, annotated clinical samples that include tissue and fluids. The tissue and fluid samples may include those with confirmed diagnoses, clinical outcomes, and controls. The samples used in combination with the present invention include the needed clinical information on therapy and outcome to perform these tests. This is a level of testing that is becoming more frequently required by FDA, payors, and practitioners.

In one embodiment, the number of clinical samples used is preferably between about 50 and about 500 samples. More preferably, the number of clinical samples used is between about 100 and about 300 samples. Most preferably, the number of clinical samples used is between about 150 and about 250 samples. In another embodiment, the number of clinical samples used is preferably about 50 or more. More preferably, the number of clinical samples used is about 200 or more. Most preferably, the number of clinical samples used is about 500 or more.

One embodiment of the present invention also generates and stores reference standards. In this embodiment, reference standards include a collection of analytes, control calibrators, and other reagents required for assay testing and evaluation. The collection may be manipulated in any desired way, e.g., by manufacturing additional samples.

The present invention also includes the ability to generate revenue in order to sustain the evaluation and validation of the diagnostic tests. For instance, one option is to charge customer entities a flat fee for evaluation and validation. The fee may be based on the complexity, cost, and/or potential value of the product. Alternatively, in some cases payment will be by milestone payments, e.g., different points in the process, or royalties based on licensing or sales of the product once it is approved for sale.

### EXAMPLES

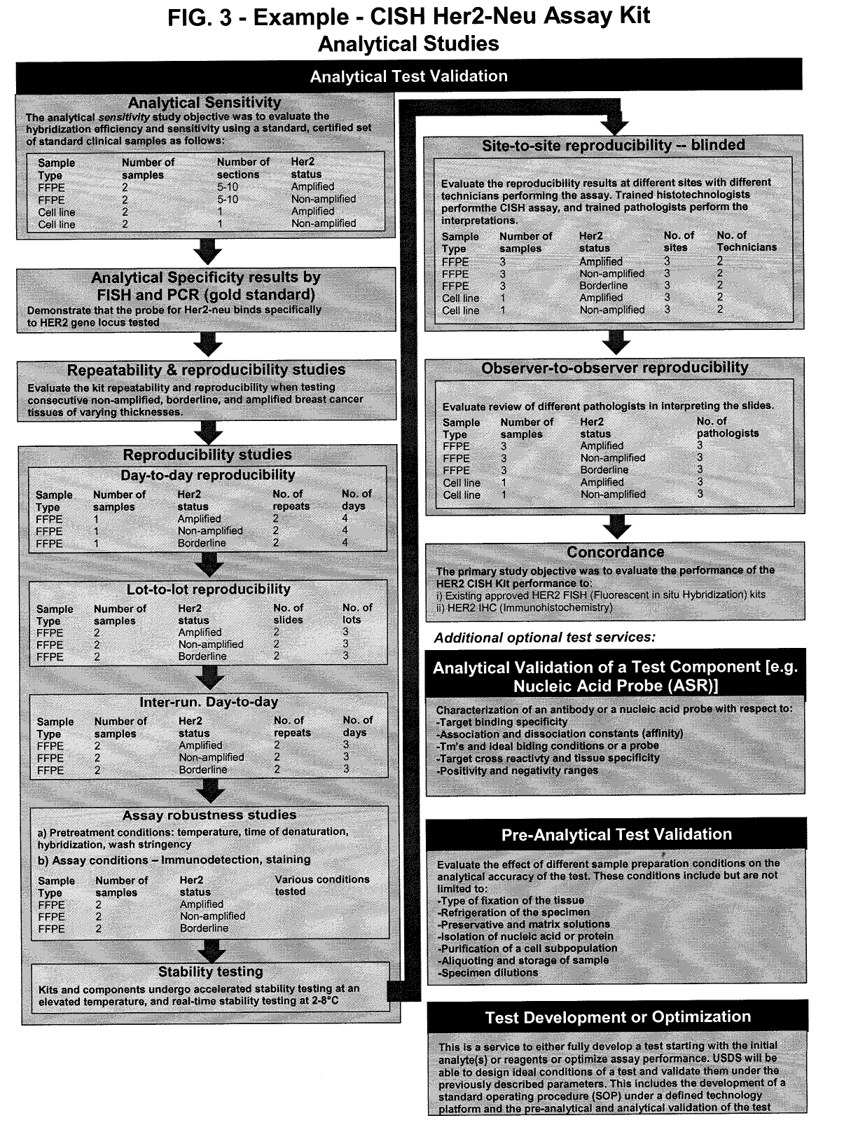

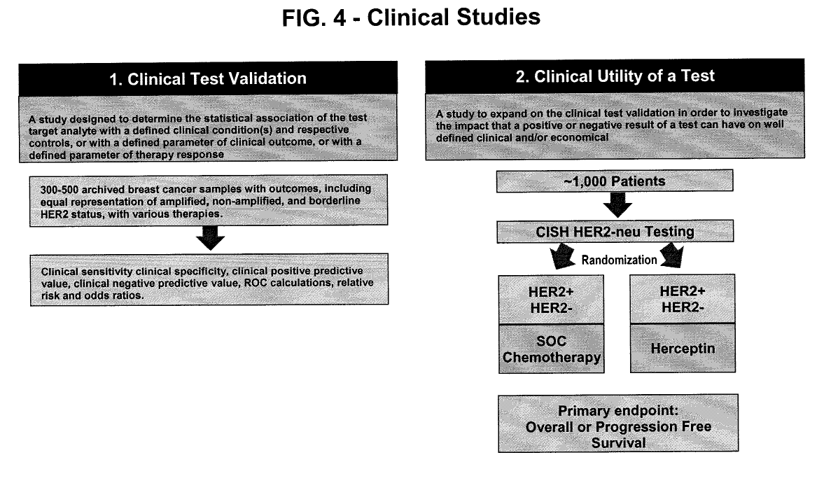

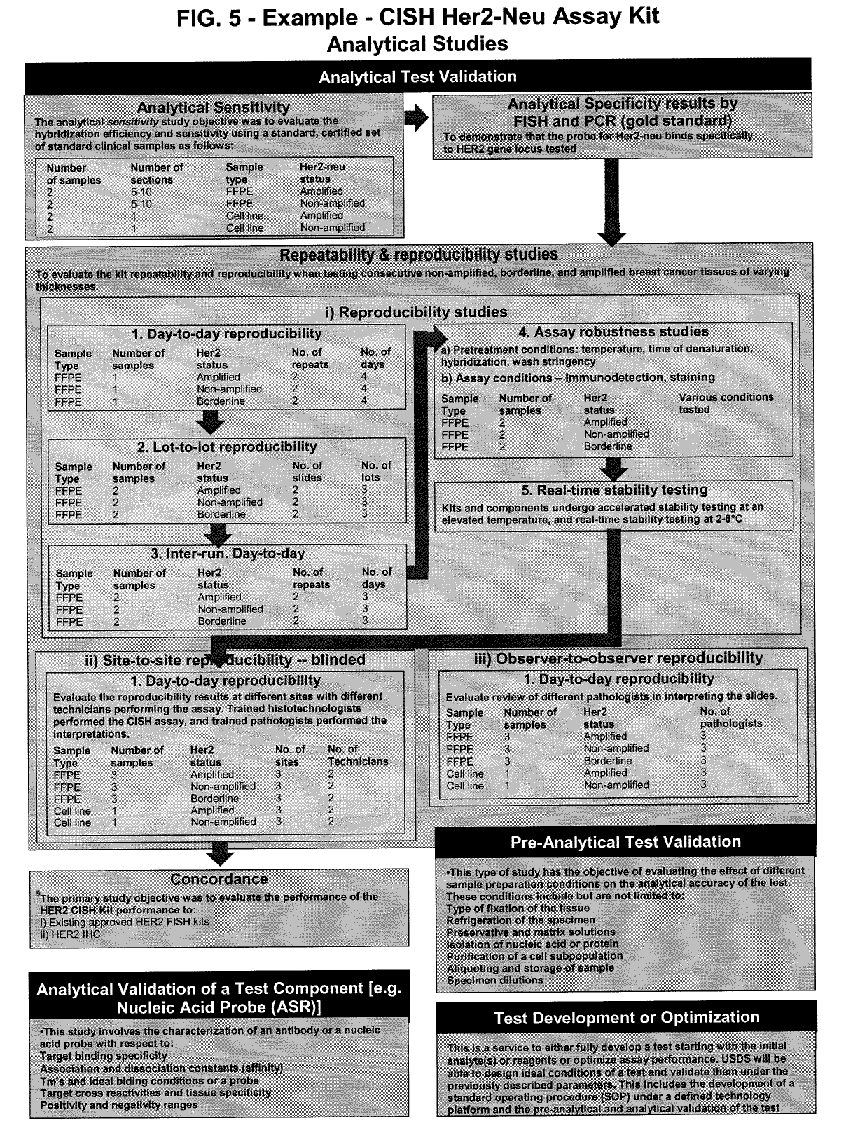

With reference to FIGS. 3-5, The following description describes an exemplary implementation of the method of the present invention. Those skilled in the art will understand that the following example is not intended to limit the present invention.

According to one aspect, the diagnostic evaluation processes include at least four steps including:
(1) Analytical performance
(2) Clinical validation and utility
(3) Optimized diagnostic marker combinations
(4) Comparative analysis of diagnostic tests

The underpinning of all three categories of the standardization of diagnostics evaluation are standardized Procedures and Samples, including:
a. Standard Operating Procedures (SOPs). As mentioned above, a first exemplary step of the present invention is to establish industry-wide acceptance of its SOPs, protocols and standards. To do this, a laboratory implementing the method of the present invention will obtain industry consensus for SOPs using any consensus method known to those skilled in the art. An example of a consensus method that may be used can be found at the following webpage, reported by the C-Path Predictive Safety test Consortium: http://www.c-path.org/Portals/0/FDA%20European%20Medicines%20Agency%20to%20Consider %20Additional%20Test%20Re%20%20.pdf
b. Sample standards. One unique feature of the present invention is a national panel of independent pathologists who establish the criteria, and then evaluate and certify samples, (in the lung cancer example these are clinical surgical pathology tissue samples) to establish the precise diagnosis, classification, histological appearance, tumor cell percentage, tissue quality, molecular quantity and purity, according to predetermined criteria established by an impartial expert panel. In the lung cancer study, the same, certified samples will be tested as the analyte by multiple diagnostic tests, thereby standardizing the clinical component. This permits comparison of the performance of multiple, independent diagnostic tests on a standard set of control and disease samples.
For future analyses of the samples, and to ensure a renewable resource of standard samples, pathologists may be involved. This process makes the clinical samples a permanent, renewable resource using (1) standardization protocols for preservation and pathology review for replacement samples to ensure replacements are matched with originals, on average, by the same set of criteria as above. The permanent standard sample bank may be used for comparison of the analytical performance of any test with similar tests under the same standards and controls.

### Evaluation Categories

(1) Analytical Evaluations are conducted on diagnostic tests, judging them against clinical samples that represent either disease or established controls. Measures are of sensitivity, specificity, positive and negative predictive values, reproducibility, linearity, robustness.
(2) Clinical Test Validation and Utility A study is preferably designed to determine the statistical association of the test target analyte with a defined clinical condition(s) and respective controls, or with a defined parameter of clinical outcome, or with a defined parameter of therapy response. The intention of this type of study is to measure statistical values like clinical sensitivity and clinical specificity, clinical positive predictive value, clinical negative predictive value, ROC calculations, relative risk and odds ratios. This type of study could be performed with retrospective clinical specimens or in a randomized prospective trial. This study may involve a comparative analysis of the test in question with other similar tests under the same set of conditions and the same clinical specimens and controls.
(3) Optimized diagnostic marker combinations The unique database is comprised of diagnostic test marker results from independent laboratories but assessed on the same standard samples under controlled conditions. From this broad dataset, proprietary best of class marker combinations may be calculated that improve on the performance of markers from individual sources. These marker combinations are derived by statistical methods to determine sensitivity, specificity, ROC curves, and/or robustness. For clinical utility and validation, clinical sensitivity and clinical specificity, clinical positive predictive value, clinical negative predictive value, ROC calculations, relative risk and odds ratios may be used.
(4) Recorded results are used to form and expand a database of analytical information for the IVD market, that will grow in both size and value with each evaluation performed. In addition to the quantitative evaluation data provided to customers, the database provides qualitative, comparative data between and among diagnostics in the market. In this manner, tests are benchmarked against the rest of the industry. Findings are suitable for filing for regulatory approval, such as by FDA.

Because standard clinical samples are used and reused, comparisons are achieved between and among diagnostic assays on the same clinical material. Therefore, all of the measurements made on any test can be compared to other tests, such as those that compete against each other. In the example of Her2-NEU CISH, the predictive value of different CISH tests can be compared to determine which test(s) have a better analytical sensitivity and a better clinical PPV and NPV.

Certification of a test may be provided based on analytical and clinical evaluation studies when a diagnostic assay meets or exceeds minimum performance criteria established by a desired laboratory or standard setting body. These criteria are preferably established by expert panels and, where, appropriate with support of regulatory agencies.

The following description implements the method described above, and applies to an exemplary Her2-NEU study.

### Pre-Analytical Studies:

For Her2-NEU CISH the pre-analytical validation is based on determination of the effects of specimen fixation conditions on the analytical sensitivity and specificity.

### Analytical Studies:

In the case of the Her2-NEU tes, the primary sequence of Her2-NEU CISH probe hybridization measurements of evaluation are base pair pair extension, sequence location, Tm (melting temperature) of the probe, optimal probe concentration necessary to generate signals to meet minimum sensitivity signals.

### Test Optimization:

For Her2-NEU CISH the SOP can be modified by optimizing the key components of the SOP such as probe size, probe sequence, hybridization conditions, signal amplification, adjustment of sensitivity. These are measured such sensitive parameters as RNA transcript or DNA gene copy numbers.

### Clinical Test Validation and Utility:

Validation of clinical sensitivity and specificity is a study designed to determine the statistical association of the test target analyte with a defined clinical condition(s) and respective controls, or with a defined parameter of clinical outcome, or with a defined parameter of therapy response. One purpose of this type of study is to measure statistical values like clinical sensitivity and clinical specificity, clinical positive predictive value, clinical negative predictive value, ROC calculations, and/or relative risk and odds ratios. This type of study may be performed with retrospective clinical specimens or in a randomized prospective trial. In addition, the study may involve a comparative analysis of the test in question with other similar tests under the same set of conditions and the same clinical specimens and controls.

For clinical utility, the diagnostic may be measured by a variety of criteria, including its ability to either predict or be associated with a clinical outcome. In the case of Her2-NEU CISH, possible primary endpoints to measure are radiological reduction of tumor size, disease-free survival, reduction of circulating tumor cells, and/or reduction of circulating Her2-Neu protein in serum.

In the case of Her2-Neu the clinical utility study specifically addresses the POSITIVE PREDICTIVE VALUE (PPV) and the NEGATIVE PREDICTIVE VALUE (NPV) of the CISH Her2-NEU test in order to predict a response to the Herceptin therapy measured by standard clinical primary endpoint measures, and to compare those with the predictive values of the existing FISH and IHC FDA approved tests.

The economic impact of the PPV or NPV of the Her2-NEU CISH test may be measured by first determining the difference of the PPV and NPV of the CISH test with respect to the standard test(s) used routinely. If the new test is able to predict no response in x % of patients that were truly non responders, the costs of unnecessary therapy, hospitalization events, and complications of therapy may be determined, on a patient by patient basis.

If the CISH test has a better PPV than existing tests, the costs associated with disease progression on those patients, otherwise negative with other tests, and who could have benefited from Herceptin therapy, will be calculated on a patient by patient basis.

Although the present invention has been described with reference to particular embodiments, it will be understood to those skilled in the art that the invention is capable of a variety of alternative embodiments within the spirit of the appended claims. For instance, although the present invention has been described with reference to particular types of diagnostic tests, those skilled in the art will understand that the method of the present invention is applicable to a wide variety of diagnostic tests. As such, the description provided herein may be adapted, modified, or changed based on the particular type of test being identified.

1. A method for standardizing and evaluating a diagnostic test, comprising the steps of:
(a) generating at least one of a standard, control, or sample required for a validation;
(b) comparing the at least one of a standard, control, or sample to at least one of an assay, protocol, or reagent for testing on a predetermined number of aspects of performance; and
(c) producing an indicator that represents the performance of the diagnostic test;
wherein steps (a), (b), and (c) are performed at a centralized location for a plurality of diagnostic tests.

2. The method of claim 1, wherein the producing comprises providing certification based on analytical and clinical evaluation studies when a diagnostic assay meets or exceeds minimum performance criteria established by a laboratory or standard setting body.

3. The method of claim 1, further comprising assessing the effectiveness of the diagnostic test.

4. The method of claim 1, wherein step (b) comprises performing at least one of:
(i) an analytical performance; or
(ii) clinical validation and utility.

5. The method of claim 4, wherein step (i) comprises performing a pre-analytical test validation.

6. The method of claim 4, wherein step (ii) comprises determining the clinical utility of a test.

7. The method of claim 1, wherein steps (a), (b), and (c) are performed on a plurality of tests to determine the effectiveness of each of the plurality of tests.

8. A method of validating a diagnostic test, comprising the steps of:
(a) isolating a target required to be identified by the diagnostic test;
(b) testing the diagnostic test's ability to identify a target analyte; and
(c) producing an indicator that represents the ability of the diagnostic test to identify a target analyte
(d) performing steps (a), (b), and (c) in a centralized location, on a plurality of different diagnostic tests, in order to determine the ability of each of the plurality of diagnostic tests to identify the target.

9. The method of claim 8, further comprising testing a clinical sample including the target.

10. The method of claim 8, wherein the isolating comprises at least one of:
determining the accuracy of the diagnostic test;
determining the precision of the diagnostic test;
determining the specificity of the diagnostic test;
determining the sensitivity of the diagnostic test;
determining the limits of the diagnostic test; or
determining the carry-over and cross-hybridization potential of the diagnostic test.

11. The method of claim 9, wherein the testing a clinical sample comprises testing the ability of the diagnostic test to detect or predict a disorder based on the target analyte.

12. The method of claim 8, further comprising determining the ability of the diagnostic test to predict treatment response.

13. The method of claim 12, wherein the determining the ability to predict treatment response comprises:
generating samples with known associated outcomes;
evaluating the diagnostic test using the generated samples; and
determining the ability of the diagnostic test to predict the known associated outcomes.

14. The method of claim 8, further comprising using a repository of reusable standard samples including one of a purified target analyte, a tissue, fluids, preserved cells, or preserved tissues.

15. The method of claim 14, further comprising using a repository of reusable standard samples including one of a target analyte, tissue, fluids, preserved cells, or preserved tissues to compare the results of the performance of different diagnostic assays against the same analyte.

16. The method of claim 14, further comprising using a repository of reusable standard samples including one of a purified target analyte, tissue, fluids, preserved cells, or preserved tissues with associated clinical information such as treatment history and outcome.

17. The method of claim 8, further comprising generating diagnostic assay testing and validation data to support submission for approval by regulatory bodies and other agencies that evaluate proficiency and performance of clinical diagnostic tests, the regulatory bodies and other agencies including at least one of FDA, EMEA (and equivalent), CAP, CLIA, ACGME, or ISO.

18. The method of claim 8, wherein the diagnostic testing and evaluation process enhances and expedites the fair evaluation of the diagnostics by regulatory bodies.

19. The method of claim 8, wherein the diagnostic testing and evaluation process enables regulatory agencies to support the introduction and utilization of valid diagnostic tests in clinical practice.

20. The method of claim 8, further comprising generating diagnostic assay data testing data to support at least one of:
(i) due diligence for licensing and investing; or
(ii) comparison to market competition.
